(19) United States
(12) Patent Application Publication
(10) Pub. No.: US 2014/0129115 A1
(43) Pub. Date: May 8, 2014

(54) START-UP CONTROL APPARATUS AND START-UP CONTROL METHOD FOR INTERNAL COMBUSTION ENGINE

(71) Applicant: Ryuta TERAYA, Gotenba-shi (JP)

(72) Inventor: Ryuta TERAYA, Gotenba-shi (JP)

(73) Assignee: TOYOTA JIDOSHA KABUSHIKI KAISHA, Toyota-shi (JP)

(21) Appl. No.: 14/069,673

(22) Filed: Nov. 1, 2013

(30) Foreign Application Priority Data
Nov. 5, 2012 (JP) 2012-243804

(51) Int. Cl. F02N 11/00

(52) U.S. Cl. CPC F02N 11/00
USPC 701/103

(57) ABSTRACT

A start-up control apparatus for an engine comprising a controller. The engine being provided in a vehicle having a plurality of shift ranges including one or both of a braking range and a manual shift range. The controller programmed to perform fuel increase control for increasing a fuel injection amount at a time of start-up of the engine. The controller being programmed to increase the fuel injection amount at a time of present start-up of the engine in a case where a selected shift range at a time of previous shutdown of the engine is the braking range or the manual shift range, as compared to a case where the selected shift range at the time of the previous shutdown of the engine is other than the braking range and the manual shift range.

### INCORPORATION BY REFERENCE

The disclosure of Japanese Patent Application No. 2012-243804 filed on Nov. 5, 2012 including the specification, drawings and abstract is incorporated herein by reference in its entirety.

### BACKGROUND OF THE INVENTION

1. Field of the Invention

The invention relates to a start-up control apparatus and a start-up control method for an internal combustion engine mounted on a vehicle. More specifically, the invention relates to a start-up control apparatus and a start-up control method for an internal combustion engine which performs control to increase a fuel injection amount at the time of start-up.

2. Description of Related Art

In a vehicle in which an internal combustion engine (hereinafter, also referred to as an engine) is provided, a fuel injection amount is temporarily increased at the time of engine start-up. Start-up performance of an engine can be improved by performing such control for increasing fuel. In addition, a reduction in exhaust emission at the time of engine start-up can be achieved. Technologies related to fuel injection amount control at the time of engine start-up include the technology described in Japanese Patent Application Publication No. 06-307270 (JP 06-307270 A). In the technology described in JP 06-307270 A, the fuel injection amount at the time of start-up (a start-up time fuel increase value) is reduced in a case where a previous engine shutdown was caused by an engine stall. Accordingly, an air-fuel mixture is prevented from becoming over-rich at the time of start-up.

In some vehicles or hybrid vehicles provided with an automatic transmission or the like, in addition to a drive range (D range) and the like, a braking range (hereinafter, also referred to as a B range) in which a braking force produced when an accelerator is released is greater than in the D range or a manual shift range (hereinafter, also referred to as a sequential shift range) can be selected.

In a vehicle in which an engine is provided, depending on a selected shift range at the time of previous engine shutdown, a catalyst atmosphere inside an exhaust gas purification catalyst (a three-way catalyst) at the time of the present engine start-up may be a lean atmosphere, which may lead to increase in an amount of NOx emission at the time of engine start-up. In particular, in a case where the selected shift range at the time of the previous engine shutdown is the B range or the sequential shift range, the catalyst atmosphere becomes a lean atmosphere during the engine shutdown process, and the amount of NOx emission may increase at the time of engine start-up.

### SUMMARY OF THE INVENTION

The invention relates to a start-up control apparatus and a start-up control method for an internal combustion engine, which are able to prevent an amount of NOx emission from increasing at a time of start-up after the internal combustion engine is shut down in a state where a selected shift range is a braking range (B range) or a manual shift range (sequential shift range).

A first aspect of the invention relates to a start-up control apparatus for an internal combustion engine, the internal combustion engine being provided in a vehicle having a plurality of shift ranges including one or both of a braking range in which a braking force produced when an accelerator is released is greater than in a normal traveling range, and a manual shift range in which a speed ratio is changed by a manual operation performed by a driver. The start-up control apparatus includes a controller. The controller is programmed to perform fuel increase control for increasing a fuel injection amount at a time of start-up of the internal combustion engine. The controller is programmed to increase the fuel injection amount at a time of present start-up of the internal combustion engine in a case where a selected shift range at a time of previous shutdown of the internal combustion engine is the braking range or the manual shift range, as compared to a case where the selected shift range at the time of the previous shutdown of the internal combustion engine is other than the braking range and the manual shift range.

In the control apparatus, in the case where the selected shift range at the time of the previous shutdown of the internal combustion engine is the braking range or the manual shift range, on condition that a coolant temperature of the internal combustion engine at the time of the present start-up is equal to or higher than a determination value set based on an amount of NOx emission, the controller may be programmed to increase the fuel injection amount at the time of the present start-up of the internal combustion engine, as compared to the case where the selected shift range at the time of the previous shutdown of the internal combustion engine is other than the braking range and the manual shift range.

According to the configuration, in consideration of the fact that an amount of NOx emission tends to increase as a combustion temperature of an internal combustion engine rises, a coolant temperature of the internal combustion engine (engine coolant temperature), at which the amount of NOx emission is large (for example, the amount of NOx emission exceeds a permissible amount), may be acquired in advance by an experiment, a simulation, or the like and a determination value for the start-up time coolant temperature may be set based on the result. By employing the configuration, it is possible to perform control for increasing the fuel injection amount at the time of start-up (fuel increase value) more appropriately.

In the control apparatus, in the case where the selected shift range at the time of the previous shutdown of the internal combustion engine is the braking range or the manual shift range, when the coolant temperature of the internal combustion engine at the time of the present start-up is lower than the determination value, the controller is programmed to set the fuel injection amount at the time of the present start-up of the internal combustion engine in the same manner as a manner in which the fuel injection amount at the time of the present start-up of the internal combustion engine is set in the case where the selected shift range at the time of the previous shutdown of the internal combustion engine is other than the braking range and the manual shift range.

In the control apparatus, in the case where the selected shift range at the time of the previous shutdown of the internal combustion engine is other than the braking range and the manual shift range, the controller may be programmed to set the fuel injection amount at the time of the present start-up of the internal combustion engine on condition that a catalyst atmosphere inside an exhaust gas purification catalyst at the time of the previous shutdown of the internal combustion engine is a stoichiometric atmosphere.

According to the configuration, since the fuel injection amount can be increased at the time of engine start-up after the internal combustion engine is shut down in a state where the selected shift range is the braking range (B range) or the manual shift range (sequential shift range), the amount of NOx emission can be prevented from increasing at the time of start-up.

A second aspect of the invention relates to a start-up control method for an internal combustion engine. The start-up control method includes selecting any of a plurality of shift ranges including one or both of a braking range in which a braking force produced when an accelerator is released is greater than in a normal traveling range, and a manual shift range in which a speed ratio is changed by a manual operation performed by a driver; increasing a fuel injection amount at a time of start-up of the internal combustion engine; and increasing the fuel injection amount at a time of present start-up of the internal combustion engine in a case where a selected shift range at a time of previous shutdown of the internal combustion engine is the braking range or the manual shift range, as compared to a case where the selected shift range at the time of the previous shutdown of the internal combustion engine is other than the braking range and the manual shift range.

According to the invention, the amount of NOx emission can be prevented from increasing at the time of start-up after the internal combustion engine is shut down in a state where the selected shift range is the braking range (B range) or the manual shift range (sequential shift range).

### BRIEF DESCRIPTION OF THE DRAWINGS

Features, advantages, and technical and industrial significance of exemplary embodiments of the invention will be described below with reference to the accompanying drawings, in which like numerals denote like elements, and wherein:

FIG. 1 is a schematic configuration diagram showing an example of a hybrid vehicle to which is applied a start-up control apparatus for an engine according to a first embodiment of the invention;

FIG. 2 is a schematic configuration diagram of the engine provided in the hybrid vehicle shown in FIG. 1 according to the first embodiment;

FIG. 3 is a block diagram showing a configuration of a control system including an ECU and the like according to the first embodiment;

FIG. 4 is a flow chart showing an example of fuel increase control at the time of engine start-up according to the first embodiment;

FIG. 5 is a schematic configuration diagram showing another example of a vehicle to which is applied a start-up control apparatus for an internal combustion engine according to a second embodiment of the invention;

FIG. 6 is a block diagram showing a configuration of a control system including an ECU and the like according to the second embodiment; and

FIG. 7 is a flow chart showing another example of fuel increase control at the time of engine start-up according to the second embodiment.

### DETAILED DESCRIPTION OF EMBODIMENTS

Hereinafter, embodiments of the invention will be described with reference to the drawings.

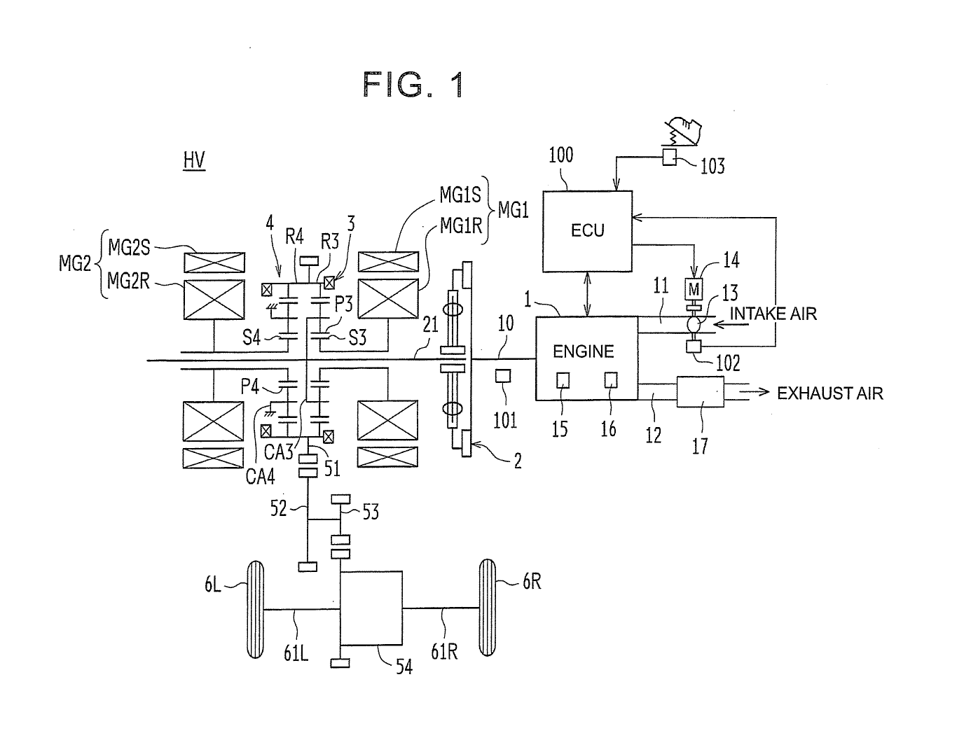

FIG. 1 is a schematic configuration diagram showing a hybrid vehicle to which is applied a start-up control apparatus for an internal combustion engine according to a first embodiment of the invention.

A vehicle shown in FIG. 1 is a front-engine, front-wheel-drive (FF) hybrid vehicle HV and includes an internal combustion engine (hereinafter, engine) 1, a first motor generator MG1, a second motor generator MG2, a power split mechanism 3, a reduction mechanism 4, a counter drive gear 51, a counter driven gear 52, a final gear 53, a differential device 54, front wheel axles (hereinafter, drive shafts) 61L and 61R, front wheels (hereinafter, drive wheels) 6L and 6R, rear wheels (driven wheels: not shown), an electronic control unit (hereinafter, ECU) 100, and the like. The engine 1 generates a drive force for driving the vehicle. The first motor generator MG1 functions mainly as a generator. The second motor generator MG2 functions mainly as a motor. The start-up control apparatus for an internal combustion engine according to this embodiment is realized by a program executed by the ECU 100.

For example, the ECU 100 is constituted by a hybrid ECU, an engine ECU, a battery ECU, and the like. These ECUs are connected so as to be able to communicate with each other.

Next, components such as the engine 1, the motor generators MG1 and MG2, the power split mechanism 3, the reduction mechanism 4, and the ECU 100 will be described.

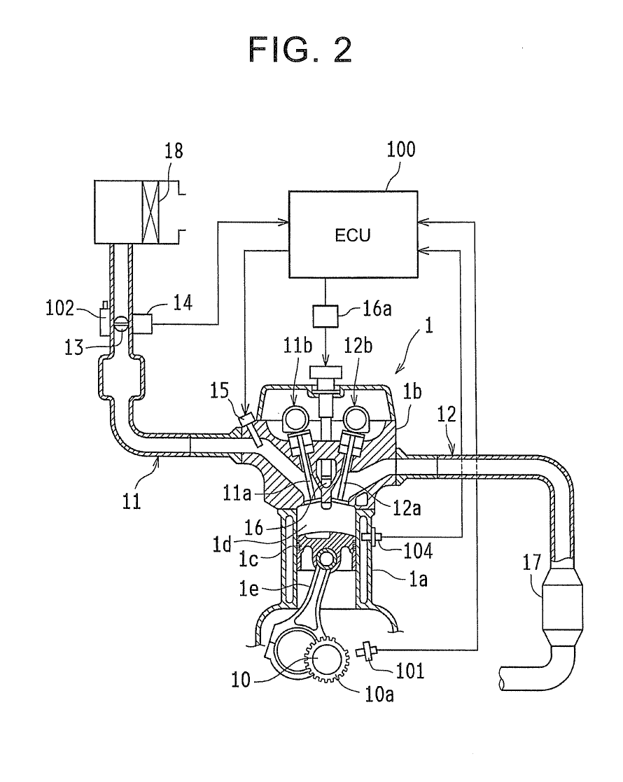

First, a schematic configuration of the engine 1 will be described with reference to FIG. 2. FIG. 2 shows only a configuration of one cylinder of the engine 1.

The engine 1 shown in FIG. 2 is d four-cylinder gasoline engine having a port injection configuration. Pistons 1c, which reciprocate in an up-down direction, are provided inside a cylinder block 1a that constitutes cylinders of the engine. Each of the pistons 1c is coupled to a crankshaft 10 via a connecting rod 1e. A reciprocating motion of the piston 1c is converted by the connecting rod 1e into a rotation of the crankshaft 10.

A signal rotor 10a is attached to the crankshaft 10. A crank position sensor 101 which detects a crank angle is arranged in a lateral vicinity of the signal rotor 10a. For example, the crank position sensor 101 is an electromagnetic pickup. The crank position sensor 101 generates pulsed signals (voltage pulses) corresponding to teeth of the signal rotor 10a when the crankshaft 10 rotates. An engine rotation speed can be calculated from an output signal of the crank position sensor 101.

A coolant temperature sensor 104 which detects a temperature of engine coolant (hereinafter, engine coolant temperature) is arranged in the cylinder block 1a of the engine 1. A cylinder head 1b is provided at an upper end of the cylinder block 1a. A combustion chamber 1d is formed between the cylinder head 1b and the piston 1c. A spark plug 16 is arranged in the combustion chamber 1d of the engine 1. An ignition timing of the spark plug 16 is adjusted by an igniter 16a.

An intake passage 11 and an exhaust passage 12 are connected to the combustion chamber 1d of the engine 1. An air cleaner 18 which filters intake air, a throttle valve 13, and the like are arranged in the intake passage 11 of the engine 1. The throttle valve 13 adjusts an intake air amount of the engine 1. The throttle valve 13 is driven by a throttle motor 14. An opening amount of the throttle valve 13 is detected by a throttle opening amount sensor 102. The ECU 100 performs drive control for the throttle valve 13 to control a throttle opening amount of the throttle valve 13.

As the control of the throttle valve 13, for example, electronic throttle control is employed in which the throttle opening amount is controlled so as to obtain an optimal intake air amount (hereinafter, a target intake amount) in accordance with a state of the engine 1 such as an engine rotation speed and a depression amount of an accelerator pedal operated by the driver (hereinafter, an accelerator depression amount). In such electronic throttle control, an actual throttle opening amount of the throttle valve 13 is detected using the throttle opening amount sensor 102. Then, the throttle motor 14 for the throttle valve 13 is controlled through feedback such that the actual throttle opening amount matches the throttle opening amount (target throttle opening amount) at which the target intake amount is obtained.

An intake valve 11a is provided between the intake passage 11 and the combustion chamber 1d of the engine 1. The intake passage 11 and the combustion chamber 1d are communicated with each other or cut off from each other by driving the intake valve 11a so as to open or close. In addition, an exhaust valve 12a is provided between the exhaust passage 12 and the combustion chamber 1d. The exhaust passage 12 and the combustion chamber 1d are communicated with each other or cut off from each other by driving the exhaust valve 12a so as to open or close. The intake valve 11a and the exhaust valve 12a are driven so as to open or close, by respective rotations of an intake camshaft 11b and an exhaust camshaft 12b. A rotation of the crankshaft 10 is transmitted to the intake camshaft 11b and the exhaust camshaft 12b via a timing chain and the like to rotate the intake camshaft 11b and the exhaust camshaft 12b.

A fuel injection valve (hereinafter, injector) 15 configured to inject fuel is arranged in the intake passage 11 (or an intake port). The injector 15 is provided for each cylinder. Fuel stored in a fuel tank (not shown) of a fuel supply system is supplied to each injector 15, and thus, the fuel is injected into the intake passage 11 by the injector 15. The injected fuel is mixed with intake air to produce an air-fuel mixture, which is then introduced into the combustion chamber 1d of the engine 1. The air-fuel mixture introduced to the combustion chamber 1d combusts and explodes upon being ignited by the spark plug 16. A high-temperature, high-pressure combustion gas that is produced at this time causes the piston 1c to reciprocate, which in turn rotates the crankshaft 10 to produce a drive force (hereinafter, an output torque) of the engine 1. The combustion gas is discharged to the exhaust passage 12 as the exhaust valve 12a opens.

A three-way catalyst 17 is arranged in the exhaust passage 12. In the three-way catalyst 17, CO and HC in the exhaust gas discharged into the exhaust passage 12 from the combustion chamber 1d are oxidized and NOx in the exhaust gas are reduced, and thus, CO, HC, and NOx are converted to harmless CO₂, H₂O, and N₂ so as to purify the exhaust gas.

Output of the engine 1 that is configured as described above is transmitted to an input shaft 21 via an output shaft (hereinafter, crankshaft) 10 of the engine and a damper 2 (refer to FIG. 1). The damper 2 is, for example, a coil spring-type transaxle damper and absorbs torque fluctuation of the engine 1.

Next, the motor generators will be described. As shown in FIG. 1, the first motor generator MG1 is an alternating current (AC) synchronous generator that includes a rotor MG1R and a stator MG1S and functions as both a generator and a motor (an electric motor). The rotor MG1R is constituted by a permanent magnet that is supported so as to be relatively rotatable with respect to the input shaft 21. The stator MG1S is configured such that a three-phase winding is wound around the stator MG1S. Similarly, the second motor generator MG2 is an AC synchronous generator that includes a rotor MG2R and a stator MG2S and functions as both a motor (an electric motor) and a generator. The rotor MG2R is constituted by a permanent magnet that is supported so as to be relatively rotatable with respect to the input shaft 21. The stator MG2S is configured such that a three-phase winding is wound around the stator MG2S.

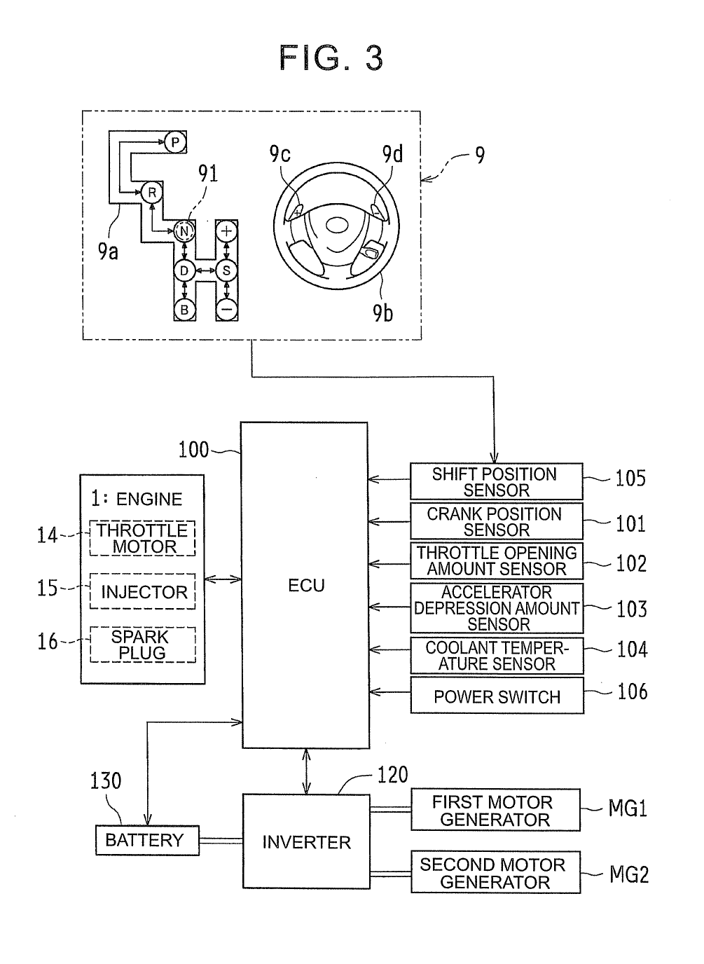

As shown in FIG. 3, each of the first motor generator MG1 and the second motor generator MG2 is connected to a battery 130 via an inverter 120. The inverter 120 is controlled by the ECU 100. Regeneration or powering (or assisting) of each of the motor generators MG1 and MG2 is selected by control performed by the inverter 120. Regenerative power in this case is charged into the battery 130 via the inverter 120. Power for driving each of the motor generators MG1 and MG2 is supplied from the battery 130 via the inverter 120.

Next, the power split mechanism will be described. As shown in FIG. 1, the power split mechanism 3 is constituted by a planetary gear mechanism that includes a sun gear S3, a pinion gear P3, a ring gear R3, and a planetary carrier CA3. The sun gear S3 is an external gear that rotates on its own axis at a center of a plurality of gear elements. The pinion gear P3 is an external gear that rotates on its own axis while revolving around and contacting an outer periphery of the sun gear S3. The ring gear R3 is an internal gear that is formed in a shape of a hollow ring so as to mesh with the pinion gear P3. The planetary carrier CA3 supports the pinion gear P3 and rotates on its own axis via the revolution of the pinion gear P3.

The planetary carrier CA3 is coupled to the input shaft 21 on the side of the engine 1 so that the planetary carrier CA3 rotates together with the input shaft 21. The sun gear S3 is coupled to the rotor MG1R of the first motor generator MG1 so that the sun gear S3 rotates together with the rotor MG1R. The ring gear R3 is coupled to drive shafts 61L and 61R (or drive wheels 6L and 6R) via the counter drive gear 51, the counter driven gear 52, the final gear 53, and the differential device 54.

In the power split mechanism 3 configured as described above, when a reaction torque produced by the first motor generator MG1 is input to the sun gear S3 in response to an output torque of the engine 1 that is input to the planetary carrier CA3, the ring gear R3, which acts as an output element, outputs a torque larger than the torque input from the engine 1. In this case, the first motor generator MG1 functions as a generator. When the first motor generator MG1 functions as a generator, a drive force of the engine 1 that is input from the planetary carrier CA3 is distributed to the sun gear S3 and the ring gear R3 according to a gear ratio between the sun gear S3 and the ring gear R3.

When a start-up of the engine 1 is required, the first motor generator MG1 functions as a motor, in other words, a starter motor. In this case, a drive force of the first motor generator MG1 is supplied to the crankshaft 10 via the sun gear S3 and the planetary carrier CA3 to crank the engine 1.

When the vehicle is traveling, if a rotation speed of the ring gear R3 is constant in the power split mechanism 3, a rotation speed of the engine 1 can be continuously (or steplessly) varied by increasing or reducing a rotation speed of the first motor generator MG1. In other words, the power split mechanism 3 functions as a speed change portion.

The reduction mechanism will be described below. The reduction mechanism 4 is constituted by a planetary gear mechanism that includes a sun gear S4, a pinion gear P4, and a ring gear R4. The sun gear S4 is an external gear that rotates on its own axis at a center of a plurality of gear elements. The pinion gear P4 is an external gear which is rotatably supported by a carrier (in this case, a transaxle case) CA4 and which rotates on its own axis while contacting an outer periphery of the sun gear S4. The ring gear R4 is an internal gear that is formed in the shape of a hollow ring so as to mesh with the pinion gear P4. The ring gear R4 of the reduction mechanism 4, the ring gear R3 of the power split mechanism 3, and the counter drive gear 51 are integrated with one another. The sun gear S4 is coupled to the rotor MG2R of the second motor generator MG2 so that the sun gear S4 rotates together with the rotor MG2R.

The reduction mechanism 4 reduces the speed of the rotation output from the second motor generator MG2 at an appropriate speed reduction ratio. The rotation whose speed has been reduced is transmitted to the left and right drive wheels 6L and 6R via the counter drive gear 51, the counter driven gear 52, the final gear 53, the differential device 54, and the drive shafts 61L and 61R.

Next, a shift operating device and shift modes will be described. The hybrid vehicle HV according to this embodiment is provided with a shift operating device 9 as shown in FIG. 3. The shift operating device 9 is arranged in a vicinity of the driver's seat and is provided with a shift lever 91 that is operable to be moved. A shift gate 9a is formed in the shift operating device 9. The shift gate 9a has a parking range (P range), a reverse range (R range), a neutral range (N range), a drive range (D range), a brake range (B range), and a sequential shift range (S range: hereinafter, also referred to as SSS range). The P range is a range for parking. The R range is a range for traveling rearward (a rearward traveling range). The N range is a range of a neutral position. The D range is a range for traveling forward (a forward traveling range). The B range is a range for traveling forward in which a braking force produced when the accelerator is released (i.e., a so-called engine brake) is greater than in the D range. The S range, in other words, the SSS range is a range in which a speed ratio is changed by a manual operation performed by the driver. A driver can move the shift lever 91 to a desired range. Respective range positions of the P range, the R range, the N range, the D range, the B range, and the S range are detected by a shift position sensor 105. The respective range positions detected by the shift position sensor 105 include a “+” position and a “−” position of the S range described below.

In a state where the shift lever 91 is in the D range, the shift mode of a hybrid system is set to an “automatic shift mode”. In the automatic shift mode, electric stepless shift control is performed in which the speed ratio is controlled so that an operating point of the engine 1 is located on an optimal fuel efficiency operation line.

In a state where the shift lever 91 is in the S range, the shift mode of the hybrid system is set to a “manual shift mode”, in other words, a “sequential shift mode”. A “+” position and a “−” position are provided ahead of and behind the S range, respectively. The “+” position is a position to which the shift lever 91 is moved when a manual upshift is performed. On the other hand, the “−” position is a position to which the shift lever 91 is moved when a manual downshift is performed. When the shift lever 91 is in the S range, if the shift lever 91 is moved to the “+” position or the “−” position from the S range that is assumed to be a neutral position, a pseudo gear that is achieved by the hybrid system is shifted up or down. The pseudo gear is a gear that is changed in a stepwise manner by, for example, controlling the first motor generator MG1 so as to adjust the rotation speed of the engine. Specifically, the gear is shifted up by one step when the shift lever 91 is moved to the “+” position one time. For example, the gear is shifted up by one step at a time, in order from the first gear to the sixth gear, in other words, in the order of the first gear, the second gear, the third gear, the fourth gear, the fifth gear, and the sixth gear. On the other hand, the gear is shifted down by one step when the shift lever 91 is moved to the “−” position one time. For example, the gear is shifted down by one step at a time, in order from the sixth gear to the first gear, in other words, in the order of the sixth gear, the fifth gear, the fourth gear, the third gear, the second gear, and the first gear. The number of gears selectable in the manual shift mode is not limited to “6 gears” and may be another number such as “4 gears” or “8 gears”.

A steering wheel 9b (refer to FIG. 3) which is arranged in front of the driver's seat is provided with paddle switches 9c and 9d. Respective operation signals of the paddle switches 9c and 9d are input to the ECU 100. In this embodiment, the paddle switches 9c and 9d have lever shapes. For example, the paddle switch 9c is an upshift paddle switch that is used in the manual shift mode to output a command signal for requesting an upshift and the paddle switch 9d is a downshift paddle switch that is used in the manual shift mode to output a command signal for requesting a downshift. A “+” symbol is affixed to the upshift paddle switch 9c and a “−” symbol is affixed to the downshift paddle switch 9d. When the shift lever 91 is moved to the “S range” and thus the “manual shift mode” is in effect, if the upshift paddle switch 9c is operated one time, for example, the upshift paddle switch 9c is pulled closer to the driver one time, the gear is shifted up by one step. On the other hand, if the downshift paddle switch 9d is operated one time, for example, the downshift paddle switch 9d is pulled closer to the driver one time, the gear is shifted down by one step.

In the hybrid system according to this embodiment, when the shift lever 91 is moved to the “D position” and thus the “automatic shift mode” is in effect, drive control is performed so that the engine 1 is efficiently operated. Specifically, the hybrid system is controlled so that the operating point of the engine 1 is located on the optimal fuel efficiency line. On the other hand, when the shift lever 91 is moved to the “S range” and thus the “manual shift mode (S mode)” is in effect, the speed ratio that is a ratio of the rotation speed of the engine 1 to the rotation speed of the ring gear R3 (a ring gear shaft) can be varied in, for example, six steps (the first gear to the sixth gear) in accordance with shifting operations performed by the driver. In this case, the first gear is a gear at which the speed ratio is largest, and the sixth gear is a gear at which the speed ratio is smallest.

A power switch will be described below. The hybrid vehicle HV in this example is provided with a power switch 106 (refer to FIG. 3) for switching between start-up and shutdown of the hybrid system. The power switch 106 is, for example, a bouncing push switch. The power switch 106 is configured so that every time a push operation of the power switch 106 is performed, the state of the power switch 106 is changed from an on state to an off state, or from the off state to the on state. In the hybrid system, the engine 1 and the motor generators MG1 and MG2 are used as sources of a drive force for traveling. The hybrid system is a system that controls travel of the hybrid vehicle HV by executing various controls including operation control for the engine 1, drive control for the motor generators MG1 and MG2, and cooperation control for the engine 1 and the motor generators MG1 and MG2.

When the power switch 106 is operated by the driver, the power switch 106 outputs a signal corresponding to the operation to the ECU 100. The signals output to the ECU 100 by the power switch 106 include an IG-On command signal or an IG-Off command signal. The ECU 100 starts up or shuts down the hybrid system based on the signal output from the power switch 106 or the like.

Specifically, when the power switch 106 is operated while the hybrid vehicle HV is stationary, the ECU 100 starts up the hybrid system in the P range. Accordingly, the vehicle is brought to a travelable state. A travelable state of the vehicle refers to a state in which vehicle travel can be controlled by a command signal of the ECU 100 and in which the hybrid vehicle HV is able to start and travel if the accelerator is depressed by the driver (hereinafter, a Ready-On state). The Ready-On state includes a state in which the second motor generator MG2 enables the hybrid vehicle HV to start and travel while the engine 1 is in a shutdown state.

For example, when the hybrid system is operating and the hybrid vehicle HV is stationary and in the P range, the ECU 100 shuts down the hybrid system if the power switch 106 is operated. Operations of the power switch 106 in this case include, for example, a short push.

Next, the ECU will be described. The ECU 100 is a controller that operates the hybrid system described above. The ECU 100 includes a central processing unit (CPU), a read only memory (ROM), a random access memory (RAM), a backup RAM, and the like.

The ROM stores various control programs, maps which are referred to when the various control programs are executed, and the like. The CPU executes arithmetic processing based on the various control programs and the maps stored in the ROM. The RAM is a memory which temporarily stores the result of computations performed by the CPU, data input from respective sensors, and the like. The backup RAM is a non-volatile memory which stores data and the like to be saved, for example, when the ignition is off.

As shown in FIG. 3, the ECU 100 is connected to the crank position sensor 101, the throttle opening amount sensor 102, the accelerator depression amount sensor 103, the coolant temperature sensor 104, the shift position sensor 105, the power switch 106, and the like. The crank position sensor 101 detects a rotation speed of the crankshaft 10 that is the output shaft of the engine 1, in other words, the engine rotation speed. The throttle opening amount sensor 102 detects an opening amount of the throttle valve 13. The accelerator depression amount sensor 103 detects the depression amount of the accelerator pedal. The coolant temperature sensor 104 detects the engine coolant temperature. Further, the ECU 100 is connected to sensors each of which indicates an operating state of the engine 1 such as an airflow meter, an intake air temperature sensor, an air-fuel ratio sensor, and an O₂ sensor. Signals from the respective sensors are input to the ECU 100. The airflow meter detects an intake air amount. The intake air temperature sensor detects an intake air temperature. The air-fuel ratio sensor detects an air-fuel ratio A/F (exhaust A/F) in the exhaust gas. The O₂ sensor detects an oxygen concentration in the exhaust gas.

The ECU 100 is connected to the throttle motor 14 that drives the throttle valve 13 of the engine 1 so as to open or close, the injector 15, the spark plug 16 (the igniter 16a), and the like.

When the hybrid system is started up (i.e., the hybrid vehicle HV is brought to a Ready-On state) by an operation of the power switch 106, for example, the ECU 100 calculates a required drive force Pr using a map (an arithmetic formula) based on an actual accelerator depression amount Acc that is obtained from an output signal of the accelerator depression amount sensor 103. Subsequently, the hybrid system (the engine 1 and the motor generators MG1 and MG2), which is the drive source, controls the drive force output to the drive wheels 6L and 6R by setting the required drive force Pr as a target drive force.

The ECU 100 executes “travel mode control” and “fuel increase control at the time of engine start-up (in other words, start-up control)” described below.

Next, the travel mode control will be described. The hybrid vehicle HV according to this embodiment travels using only the second motor generator MG2, when operation efficiency of the engine 1 is low during start, low-speed travel, and the like, (in other words, “the hybrid vehicle HV travels in an EV travel mode). In addition, the hybrid vehicle HV also travels in the EV travel mode when the driver selects the EV travel mode using a travel mode selection switch arranged inside a vehicle cabin.

On the other hand, during normal travel, the hybrid vehicle HV travels using only the engine 1 (in other words, “the hybrid vehicle HV travels in an engine travel mode”). Furthermore, during high-speed travel, power from the battery 130 is supplied to the second motor generator MG2 in order to increase output of the second motor generator MG2 and add the drive force to the drive wheels 6L and 6R. This addition of the drive force means drive force assistance, in other words, powering.

During deceleration, the second motor generator MG2 functions as a generator and performs power regeneration, and power recovered by the regeneration is stored in the battery 130. When an amount of charge in the battery 130 declines and charging is particularly necessary, the output of the engine 1 is increased in order to increase the amount of power generated by the first motor generator MG1 and to increase the amount of charge in the battery 130. In some cases during low-speed travel, control for increasing the drive force of the engine 1 may also be performed if needed. Examples of such cases include a case where charging of the battery 130 is required, a case where auxiliary machines such as an air conditioner is driven, a case where the temperature of the coolant of the engine 1 is raised to a predetermined temperature, and a case where the vehicle accelerates rapidly.

In the hybrid vehicle HV according to this embodiment, when it is determined that an EV travel condition is fulfilled based on the operating state of the hybrid vehicle HV, the state of the battery 130, and the like, the engine 1 is shut down in order to improve fuel efficiency. Subsequently, when the EV travel condition becomes unfulfilled, the engine 1 is restarted. Thus, in the hybrid vehicle HV, the engine 1 is intermittently operated even if the power switch 106 is at the ON position. A timing at which the engine 1 is restarted after the engine is shut down during an intermittent operation of the engine will also be referred to as an “intermittent start time”.

Hereinafter, the fuel increase control at the time of engine start-up will be described. In the hybrid vehicle HV shown in FIG. 1, the amount of NOx emission increases at the time of initial engine start-up after the hybrid vehicle HV is brought to the Ready-On state. In other words, in the hybrid vehicle HV, fuel cutoff is performed when the vehicle is decelerated in a state in which the selected shift range is B range or the SSS range, that is, when an engine brake request is made. In the hybrid vehicle HV according to this embodiment, in a case where the engine is shutdown while the selected shift range is the B range or the SSS range, the piston stops while fuel cutoff is continued in an engine-driven state. In this case, since exhaust A/F becomes lean and the catalyst atmosphere inside the three-way catalyst 17 becomes excessively lean during the engine shutdown process, the amount of NOx emission may increase at the time of initial engine start-up thereafter (at the time of initial engine start-up after the hybrid vehicle HV is brought to the Ready-On state).

In start-up control to which the invention is not applied, the above points are not taken into consideration. In other words, a fuel injection amount at the time of start-up (or a start-up time fuel increase value) is set on condition that the catalyst atmosphere inside the three-way catalyst 17 at the time of engine start-up (a start-up time catalyst atmosphere) is stoichiometric irrespective of the time of initial engine start-up after the hybrid vehicle HV is brought to the Ready-On state. Therefore, it may be difficult to prevent an increase in the amount of NOx emission due to the excessively lean catalyst atmosphere.

When the selected shift range is the D range in the hybrid vehicle HV, fuel cutoff during deceleration is not performed. Therefore, the excessively lean catalyst atmosphere is unlikely to occur. At an intermittent start time after the initial engine start-up after the hybrid vehicle HV is brought to the Ready-On state, the operating state at the time of previous engine shutdown is recognized, and therefore, an appropriate start-up time fuel increase value can be set at the intermittent start time. The operating state at the time of the previous engine shutdown is, for example, the catalyst atmosphere inside the three-way catalyst 17.

As described above, in the hybrid vehicle HV, the amount of NOx emission may increase at the time of initial engine start-up after the engine 1 is shut down in a state in which the selected shift range is the B range or the SSS range. In this embodiment, in a case where the selected shift range at the time of previous engine shutdown (at the time of final engine shutdown while the hybrid vehicle HV is in the Ready-On state) is the B range or the SSS range, control is performed so as to increase a fuel increase value at the time of present engine start-up (at the time of initial engine start-up after the hybrid vehicle HV is brought to the Ready-On state) as compared to a case where the selected shift range at the time of the previous engine shutdown is other than the B range and the SSS range. The fuel increase control at the time of engine start-up will be described below in detail.

First, before describing the fuel increase control at the time of engine start-up, maps that are used for the fuel increase control will be described with reference to Table 1 and Table 2.

TABLE 1

| | | | | | | | |
|---|---|---|---|---|---|---|---|
| Engine coolant | 0 | 20 | 40 | 60 | 80 | 100 | 110 |
| temperature (° C.) | | | | | | | |
| Start-up time fuel | B₀ | B₂₀ | B₄₀ | B₆₀ | B₈₀ | B₁₀₀ | B₁₁₀ |
| increase coefficient B | | | | | | | |

TABLE 2

| | | | | | | | |
|---|---|---|---|---|---|---|---|
| Engine coolant | 0 | 20 | 40 | 60 | 80 | 100 | 110 |
| temperature (° C.) | | | | | | | |
| Start-up time fuel | — | — | A₄₀ | A₆₀ | A₈₀ | A₁₀₀ | A₁₁₀ |
| increase coefficient A | | | (B₄₀ × | (B₆₀ × | (B₈₀ × | (B₁₀₀ × | (B₁₁₀ × |
| | | | 1.5) | 1.5) | 1.5) | 1.5) | 1.5) |

The map (table) shown in Table 1 is a fuel increase value map used in the case where the selected shift range at the time of the previous engine shutdown is other than the B range and the SSS range (for example, the selected shift range is the D range). In the case of the hybrid vehicle HV, for example, the phrase “at the time of the previous engine shutdown” means “at the time of the previous final engine shutdown”.

In the map shown in Table 1, a coefficient B (B₀ to B₁₁₀) is set using the engine coolant temperature (0° C., 20° C., 40° C., 60° C., 80° C., 100° C., and 110° C.) as a parameter. The coefficient B is used to calculate an amount by which the fuel injection amount is increased at the time of start-up. The increased fuel injection amount at the time of engine start-up (the start-up time fuel increase value) can be obtained by reading the coefficient B from the map shown in Table 1 and multiplying a base fuel injection amount τ_{BASE} (or a base fuel increase amount) by the coefficient B.

The base fuel injection amount τ_{BASE} is, for example, a fuel injection amount necessary for the A/F (the catalyst atmosphere) to become stoichiometric (stoichiometric air-fuel ratio) at the time of engine start-up at a low temperature and is set to a value adjusted in advance by an experiment, a simulation, or the like. The base fuel injection amount τ_{BASE} is stored in the ROM of the ECU 100.

The map shown in Table 1 is a map indicating values of the increase correction coefficient, which have been adjusted in advance by an experiment, a simulation, or the like, using the engine coolant temperature as the parameter. More specifically, the map shown in Table 1 indicates the values of the increase correction coefficient at respective temperature values of 0° C., 20° C., 40° C., 80° C., 100° C., and 110° C. The map shown in Table 1 is stored in the ROM of the ECU 100. The increase correction coefficient is a coefficient that corrects the base fuel injection amount τ_{BASE} in order to make the catalyst atmosphere inside the three-way catalyst 17 at the time of engine start-up stoichiometric (or rich). In the map shown in Table 1, the coefficient B is set so that the higher the engine coolant temperature, the smaller the coefficient B.

On the other hand, the map (table) shown in Table 2 is a fuel increase coefficient map used in the case where the selected shift range at the time of the previous engine shutdown (in the case of the hybrid vehicle HV, at the time of the previous final engine shutdown) is the B range or the SSS range. In the map shown in Table 2, a coefficient A (A₄₀ to A₁₁₀) is set using the engine coolant temperature (40° C., 60° C., 80° C., 100° C., and 110° C.) as a parameter. The coefficient A is used to calculate an amount by which the fuel injection amount is increased at the time of start-up. The fuel injection amount at the time of engine start-up (or the start-up time fuel increase value) can be obtained by reading the coefficient A from the map shown in Table 2 and multiplying the base fuel injection amount τ_{BASE} by the coefficient A.

In the map shown in Table 2, the coefficient A is set in consideration of the fact that the catalyst atmosphere inside the three-way catalyst 17 becomes a lean atmosphere in the case where the engine 1 is shut down in a state where the selected shift range is the B range or the SSS range. The map is stored in the ROM of the ECU 100. In other words, the map shown in Table 2 is a map indicating the coefficient A by which a lean atmosphere inside the three-way catalyst 17 is changed to a stoichiometric (or rich) catalyst atmosphere and which has been adjusted in advance by an experiment, a simulation, or the like, by using the engine coolant temperature (40° C., 60° C., 80° C., 100° C., and 110° C.) as the parameter.

Values of the coefficient A in the map shown in Table 2 are set such that the values of the coefficient A at values of the engine coolant temperature are larger than respective values of the coefficient B at the same values of the engine coolant temperature in the map shown in Table 1. In other words, A₄₀>B₄₀, A₆₀>B₆₀, A₈₀>B₈₀, A₁₀₀>B₁₀₀, and A₁₁₀>B₁₁₀. Specifically, due to adjustment by an experiment, a simulation, or the like, the values of the coefficient A in the map shown in Table 2 are set to values that are, for example, 1.5 times the respective values of the coefficient B in the map shown in Table 1. In other words, A₄₀=1.5×B₄₀, A₆₀=1.5×B₆₀, A₈₀=1.5×B₈₀, A₁₀₀=1.5×B₁₀₀, and A₁₁₀=1.5×B₁₁₀.

Therefore, when the fuel injection amount is calculated using each value of the coefficient A in the map shown in Table 2, the fuel injection amount at the time of engine start-up (or the start-up time fuel increase value) is increased by, for example, a factor 1.5 as compared to when the fuel injection amount is calculated using the corresponding value of the coefficient B in the map shown in Table 1.

The factor, by which each value of the coefficient A is increased relative to the corresponding value of the coefficient B, is not limited to “1.5” and another value (factor) may be set as appropriate.

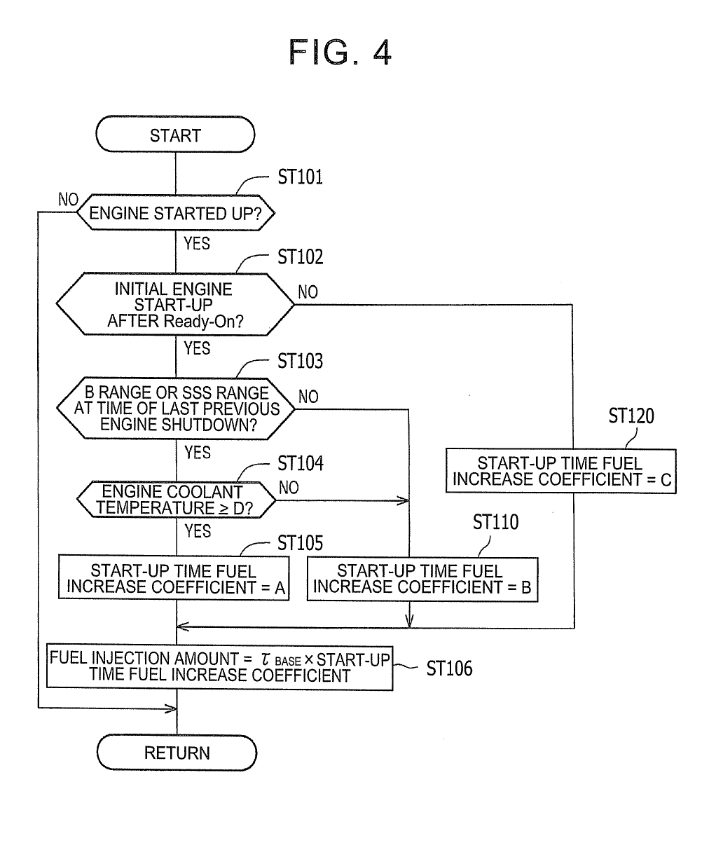

It should be noted that, in the map shown in Table 2, the start-up time fuel increase coefficient is not set for a region where the engine coolant temperature is lower than 40° C. This is because, in this first embodiment (or in a second embodiment to be described later), the coefficient A in the map shown in Table 2 is selected on condition that the engine coolant temperature is equal to or higher than a determination value D (D=40° C.) as will be described later. This condition corresponds to step ST104 in FIG. 4 or to step ST203 in FIG. 8 to be described later.

Next, the fuel increase control at the time of engine start-up which is executed by the ECU 100 will be described with reference to the flow chart shown in FIG. 4. A control routine shown in FIG. 4 is repetitively executed in predetermined periods by the ECU 100.

As processing related to the fuel increase control at the time of engine start-up, the ECU 100 executes processing in which every time the engine 1 is shut down, the selected shift range at the time of the engine shutdown is recognized based on the output signal of the shift position sensor 105 and the shift range information is stored in the RAM or the like.

When the control routine shown in FIG. 4 is started, first, in step ST101, a determination is made on whether or not the engine 1 has been started up (cranking has been started). When the determination result is a negative determination (NO), a return is made. A case where the determination result of step ST101 is a negative determination (NO) is, for example, a case where the engine has been shut down or is in operation.

When the determination result of step ST101 is a positive determination (YES), the control routine proceeds to step ST102. In step ST102, a determination is made on whether or not initial engine start-up is in progress after the hybrid vehicle HV is brought to the Ready-On state (i.e., whether or not initial engine start-up after Ready-On is in progress). When the determination result is a negative determination (NO), it is determined that intermittent start in the Ready-On state is in progress (i.e., intermittent start during Ready-On is in progress), and the control routine proceeds to step ST120.

In step ST120, a coefficient C used to calculate an amount by which the fuel injection amount is increased at the time of start-up at the intermittent start time is obtained. Specifically, for example, the intermittent start time coefficient C is obtained based on the engine coolant temperature, the exhaust A/F, an operation duration of a previous operation, an elapsed time from operation shutdown, or the like, by referring to an intermittent start time fuel increase coefficient map which is set in advance. The map used for obtaining the intermittent start time coefficient C is obtained in advance by an experiment, a simulation, or the like.

Next, in step ST106, using the coefficient C obtained in step ST120 and the base fuel injection amount τ_{BASE}, the base fuel injection amount τ_{BASE} is multiplied by the coefficient C. Accordingly, the fuel injection amount at the intermittent start time (the start-up time fuel increase value) is calculated. The fuel injection amount at the time of engine start-up (at the intermittent start time) is controlled by setting the calculated fuel injection amount as a target fuel injection amount.

When the determination result of step ST102 is a positive determination (YES) (when the initial engine start-up after Ready-On is in progress), the control routine proceeds to step ST103. In step ST103, information on the selected shift range at the time of the previous final engine shutdown (the final engine shutdown in the Ready-On state) is read out from the RAM or the like and a determination is made on whether or not the selected shift range at the time of the previous final engine shutdown is one of the B range and the SSS range.

When the determination result of step ST103 is a negative determination (NO), in other words, when the selected shift range at the time of the previous final engine shutdown is other than the B range and the SSS range (for example, the selected shift range is the D range), the control routine proceeds to step ST110. In step ST110, the coefficient B (B₀, B₂₀, B₄₀, B₆₀, B₈₀, B₁₀₀, or B₁₁₀) is obtained based on the engine coolant temperature obtained from the output signal of the coolant temperature sensor 104, by referring to the map shown in Table 1. When the value of the engine coolant temperature is a value between points on the map shown in Table 1, the coefficient B is obtained by a linear interpolation process or the like.

Next, in step ST106, using the coefficient B obtained in step ST110 and the base fuel injection amount τ_{BASE}, the base fuel injection amount τ_{BASE} is multiplied by the coefficient B to calculate the fuel injection amount at the time of engine start-up (the start-up time fuel increase value). The fuel injection amount at the time of engine start-up is controlled by setting the calculated fuel injection amount as the target fuel injection amount.

On the other hand, when the determination result of step ST103 is a positive determination (YES), in other words, when the selected shift range at the time of the previous final engine shutdown is the B range or the SSS range, it is determined that the catalyst atmosphere inside the three-way catalyst 17 is a lean atmosphere and that NOx emission is likely to increase, and the control routine proceeds to step ST104.

In step ST104, a determination is made on whether or not the engine coolant temperature obtained from the output signal of the coolant temperature sensor 104 is equal to or higher than the predetermined determination value D (D=40° C.). When the engine coolant temperature is lower than the determination value D, a negative determination (NO) is made in step ST104, and processes of step ST110 and step ST106 are executed to calculate the fuel injection amount at the time of engine start-up (the start-up time fuel increase value).

As for the determination value D used in the determination in step ST104, in consideration of the fact that the amount of NOx emission increases as the combustion temperature of the engine 1 rises, a value of the engine coolant temperature, at which the amount of NOx emission becomes large (for example, the amount of NOx emission exceeds a permissible amount), may be acquired in advance by an experiment, a simulation, or the like and the determination value D may be adjusted based on the result. In this example, 40° C. is set as the determination value D by an experiment, a simulation, or the like. The determination value D is not limited to 40° C., and another value of the coolant temperature may be set as the determination value D, as appropriate.

On the other hand, when the engine coolant temperature is equal to or higher than the determination value D, a positive determination (YES) is made in step ST104 and the control routine proceeds to step ST105.

In step ST105, the coefficient A (A₄₀, A₆₀, A₃₀, A₁₀₀, or A₁₁₀) is obtained based on the engine coolant temperature obtained from the output signal of the coolant temperature sensor 104, by referring to the map shown in Table 2. When the value of the engine coolant temperature is a value between points on the map shown in Table 2, the coefficient A is obtained by a linear interpolation process or the like.

Next, in step ST106, using the coefficient A obtained in step ST105 and the base fuel injection amount τ_{BASE}, the base fuel injection amount τ_{BASE} is multiplied by the coefficient A to calculate the fuel injection amount at the time of engine start-up (the start-up time fuel increase value). When the start-up time fuel increase value is calculated using the coefficient A in this manner, the fuel injection amount at the time of engine start-up (the start-up time fuel increase value) can be increased as compared to when the coefficient B is used. In addition, the fuel injection amount at the time of engine start-up is controlled by setting the fuel injection amount calculated in this manner as the target fuel injection amount.

As described above, according to this embodiment, in the case where the selected shift range at the time of the previous final engine shutdown is the B range or the SSS range (in other words, in the case where the B range or the SSS range had been selected at the time of the previous final engine shutdown), the fuel increase value at the time of the present start-up (at the time of the initial engine start-up after the hybrid vehicle HV is brought to the Ready-On state) can be increased as compared to the case where the selected shift range at the previous engine shutdown is other than the B range and the SSS range (i.e., the case of the engine shutdown while fuel cutoff is not performed during deceleration). Accordingly, the amount of NOx emission can be prevented from increasing at the time of initial engine start-up.

As described above, a determination on whether or not the catalyst atmosphere at the time of the present engine start-up (at the time of initial engine start-up after the hybrid vehicle HV is brought to the Ready-On state) is a lean atmosphere can be made using information on the shift range at the time of the previous final engine shutdown. Therefore, even at the time of initial engine start-up after the hybrid vehicle HV is brought to the Ready-On state, an appropriate start-up time fuel increase value can be set.

In the first embodiment described above, a determination on whether or not the shift range at the time of the previous final engine shutdown is one of the B range and the SSS range is made using information obtained from the output signal of the shift position sensor 105 (hereinafter, shift range information) at the time of the previous final engine shutdown. However, the use of shift range information is not restrictive.

For example, in a case where the shift range at the time of the initial engine start-up after the hybrid vehicle HV is brought to the Ready-On state is the B range or the SSS range, the shift range at the time of the previous final engine shutdown is also likely to be the B range or the SSS range. Therefore, the determination on whether or not the selected shift range at the time of the previous final engine shutdown is one of the B range and the SSS range may be made using the shift range information at the time of initial engine start-up after the hybrid vehicle HV is brought to the Ready-On state (at the time of the present engine start-up).

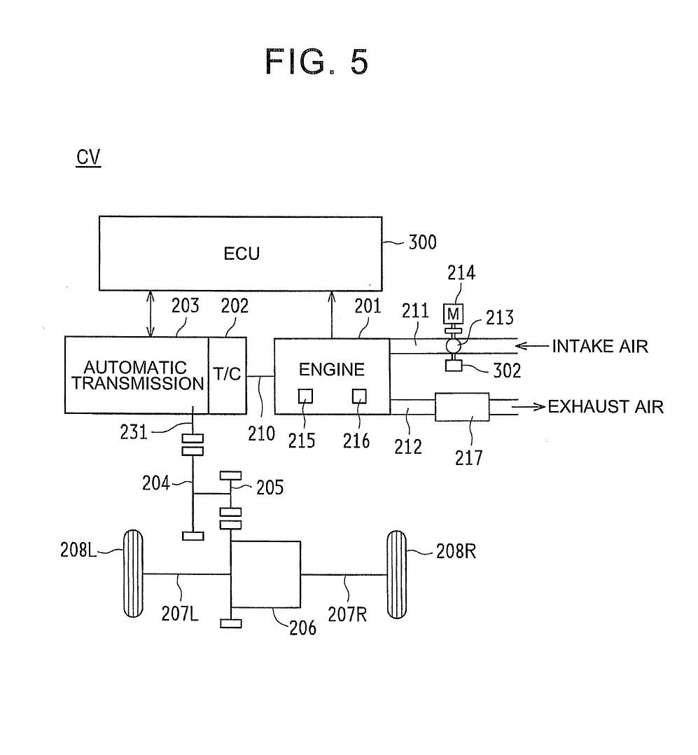

Next, the second embodiment of the invention will be described with reference to the drawings. FIG. 5 is a schematic configuration diagram of a vehicle to which is applied a start-up control apparatus for an internal combustion engine according to the second embodiment of the invention.

A vehicle CV according to this example is a front-engine, front-wheel-drive (FF) vehicle and includes an engine 201, an automatic transmission 203, a driven gear 204, a final gear 205, a differential device 206, drive shafts 207L and 207R, drive wheels 208L and 208R, an ECU 300, and the like. The automatic transmission 203 includes a torque converter 202. The start-up control apparatus for an internal combustion engine according to this embodiment is realized by a program executed by the ECU 300.

Next, components such as the engine 201, the torque converter 202, the automatic transmission 203, and the ECU 300 will be described below.

The engine 201 is a port-injection four-cylinder gasoline engine and basically has the same configuration as in the first embodiment. In other words, the engine 201 is an internal combustion engine in which an air-fuel mixture produced by mixing intake air and fuel injected from an injector 215 at an appropriate ratio is ignited by a spark plug 216 to generate rotational power. The engine 201 is configured so that the operating state of the engine 201 including a throttle opening amount (intake air amount) of a throttle valve 213 provided in an intake passage 211, a fuel injection amount (an injection timing and an injection duration of the injector 215), and an ignition timing of the spark plug 216 can be controlled. Exhaust gas after combustion passes through an exhaust passage 212 and is discharged to outside air after being purified by a three-way catalyst 217. In the three-way catalyst 217, CO and HC in the exhaust gas discharged into the exhaust passage 212 are oxidized and NOx in the exhaust gas is reduced, and thus, CO, HC, and NOx are converted to harmless CO₂, H₂O, and N₂ so as to purify the exhaust gas.

The torque converter according to this embodiment includes an input shaft-side pump impeller, an output shaft-side turbine runner, a stator, a lock-up clutch, and the like. The stator exhibits a torque amplifying function. The torque converter is a fluid coupling that transmits power using a fluid (ATF (registered trademark)) between the pump impeller and the turbine runner (between the engine 201 and the automatic transmission 203).

The automatic transmission 203 includes, for example, a primary pulley, a secondary pulley, a belt wound around the primary pulley and the secondary pulley, and the like. As the automatic transmission 203 according to this embodiment, a belt-type continuously variable transmission (CVT) which steplessly adjusts a speed ratio is used. Due to control performed by the ECU 300, in the automatic transmission (CVT) 203 in this example, it is possible to set an automatic shift mode to be described later and a manual shift mode for selecting the speed ratio (i.e., gear) among a plurality of speed ratios (gears) set stepwise in advance, as in the case of a stepped transmission.

Power of the engine 201 that has been transmitted to an output shaft of the automatic transmission 203 is transmitted to the left and right drive wheels 208L and 208R via an output gear 231, the driven gear 204, the final gear 205, the differential device 206, and the drive shafts 207L and 207R.

As the automatic transmission 203, an automatic transmission employing another system, such as a toroidal CVT or a stepped (planetary gear-type) automatic transmission in which the gear is achieved using a frictional engagement device including a clutch and a brake and a planetary gear device, may be used.

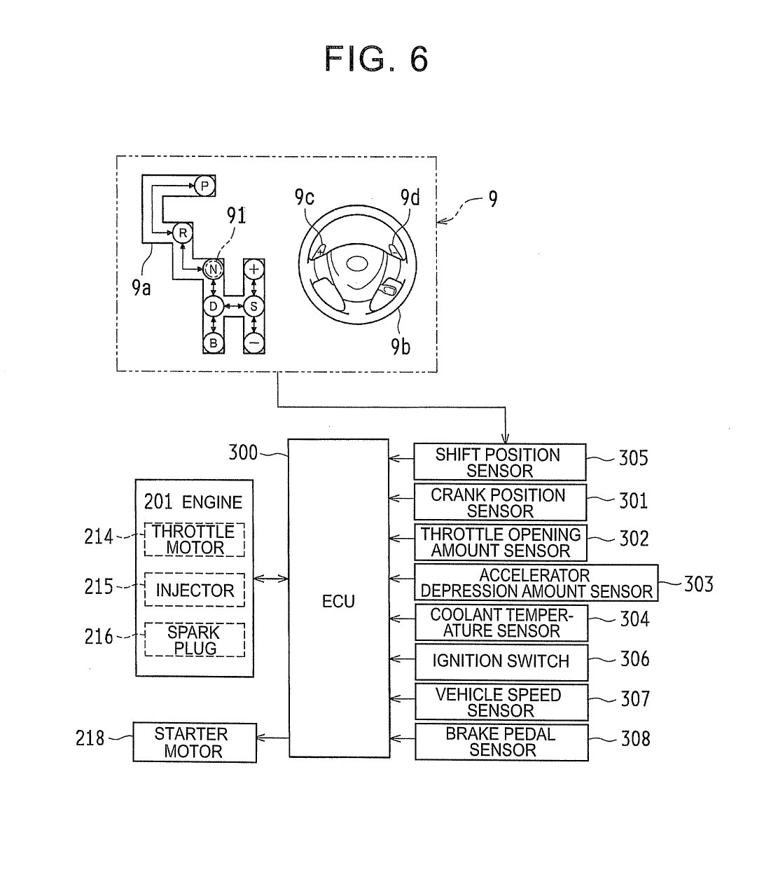

Next, a shift operating device and shift modes will be described. The vehicle CV according to this embodiment is provided with a shift operating device 9 as shown in FIG. 6. The shift operating device 9 is arranged in a vicinity of a driver's seat. The shift operating device 9 basically has the same configuration as in the first embodiment described above. Specifically, the shift operating device 9 is provided with a shift lever 91 that is operable to be moved. As in the first embodiment, a shift gate 9a is formed in the operating device 9, and the shift gate 9a has a P range, an R range, an N range, a D range, a B range (a braking range), and an S range. Thus, a driver can move the shift lever 91 to a desired range. Respective range positions of the P range, the R range, the N range, the D range, the B range, and the S range are detected by a shift position sensor 305. The respective range positions detected by the shift position sensor 105 include a “+” position and a “−” position of the S range described below.

In a state in which the shift lever 91 is in the D range, an “automatic shift mode” is set in which a target gear is determined based on vehicle speed and an accelerator depression amount by referring to a shift map set in advance, and thus shift control for the automatic transmission 203 is performed.

When the shift lever 91 is moved to the S range, a manual shift mode in which a shift operation is performed manually, in other words, a sequential mode is set. When the shift lever 91 is moved to upshift “+” or downshift “−” in the manual shift mode, a forward gear of the automatic transmission 203 is shifted up or down. Specifically, the gear is shifted up by one step when the shift lever 91 is moved to the upshift “+” one time. For example, the gear is shifted up by one step at a time, in order from the first gear to the sixth gear, in other words, in the order of the first gear, the second gear, the third, gear, the fourth gear, the fifth gear, and the sixth gear. On the other hand, the shift stage is shifted down by one step when the shift lever 91 is moved to the downshift “−” one time. For example, the gear is shifted down by one step at a time, in order from the sixth gear to the first gear, that is, in the order of the sixth gear, the fifth gear, the fourth gear, the third gear, the second gear, and the first gear. The number of gears selectable in the manual shift mode is not limited to “6 gears”, and may be another number (for example, “4 gears” or “8 gears”).

In this embodiment, an upshift switch 9c and a downshift switch 9d are provided on a steering wheel 9b arranged in front of a driver's seat of the vehicle, as in the first embodiment. Respective operation signals of the upshift switch 9c and the downshift switch 9d are input to the ECU 300.

In a case where the shift lever 91 is, for example, in the S range, when the downshift switch 9d is operated one time, a speed ratio among a plurality of speed ratios (hereinafter, gears) set stepwise in the automatic transmission 203 is shifted down by one step. On the other hand, when the upshift switch 9c is operated one time, the gear of the automatic transmission 203 is shifted up by one step.

The ECU 300 according to this embodiment includes a CPU, a ROM, a RAM, a backup RAM, and the like.

The ROM stores various control programs, maps which are referred to when the various control programs are executed, and the like. The CPU executes arithmetic processing based on the various control programs and the maps stored in the ROM. The RAM is a memory which temporarily stores the result of computations performed by the CPU, data input from respective sensors, and the like. The backup RAM is a non-volatile memory which stores data or the like to be saved during ignition off and the like.

As shown in FIG. 6, the ECU 300 is connected to a crank position sensor 301, a throttle opening amount sensor 302, an accelerator depression amount sensor 303, a coolant temperature sensor 304, the shift position sensor 305, an ignition switch 306, a vehicle speed sensor 307, a brake pedal sensor 308, and the like. The crank position sensor 301 detects a rotation speed of the crankshaft 210 that is an output shaft of the engine 201 (an engine rotation speed). The throttle opening amount sensor 302 detects an opening amount of the throttle valve 13 of the engine 201. The accelerator depression amount sensor 303 detects a depression amount of an accelerator pedal (not shown). The coolant temperature sensor 304 detects an engine coolant temperature (coolant temperature). The vehicle speed sensor 307 outputs a signal in accordance with a vehicle speed. The brake pedal sensor 308 detects a pedaling force applied to a brake pedal (brake pedaling force). Further the ECU 300 is connected to sensors each of which indicates the operating state of the engine 201, such as an airflow meter which detects an intake air amount, an intake air temperature sensor which detects an intake air temperature, an air-fuel ratio sensor which detects an A/F (exhaust A/F) in the exhaust gas, and an O₂ sensor which detects an oxygen concentration in the exhaust gas. Signals from the respective sensors are input to the ECU 300.

The ECU 300 is connected to a throttle motor 214 that drives the throttle valve 213 of the engine 201 so as to open or close, the injector 215, the spark plug (the igniter) 216, a starter motor 218 that performs cranking at the time of start-up of the engine 201, and the like.

Based on output signals of the various sensors described above, the ECU 300 executes various controls for the engine 201 including opening amount control for the throttle valve 213 of the engine 201, fuel injection amount control for the engine 201 (opening/closing control for the injector 215), and ignition timing control for the engine 201 (drive control for the spark plug 216).

The ECU 300 uses a shift map (stored in the ROM of the ECU 300) to obtain a target speed ratio based on a vehicle speed that is obtained from an output signal of the vehicle speed sensor 307 and an accelerator depression amount that is obtained from an output signal of the accelerator depression amount sensor 303. The shift map is a map in which the vehicle speed and the accelerator depression amount are used as parameters and which is used to obtain an appropriate target speed ratio (a gear at which optimal fuel efficiency can be achieved) in accordance with the vehicle speed and the accelerator depression amount. Subsequently, shift control for the automatic transmission (CVT) 203 is performed in accordance with a deviation between an actual speed ratio and the target speed ratio so that the actual speed ratio coincides with the target speed ratio (automatic shift mode). In a state in which the manual shift mode is set by an operation of the shift lever 91, the ECU 300 performs transmission control for changing the gear (speed ratio) of the automatic transmission 203 in accordance with a downshift operation or an upshift operation performed by the driver.

The ECU 300 executes stop and start control and fuel increase control at the time of engine start-up described below.

First, the stop and start control will be described. The ECU 300 is able to execute so-called stop and start control in which the engine 201 is automatically shut down when a stop condition (engine automatic shutdown condition) is satisfied and the engine 201 is automatically started up when a stop cancellation condition (engine automatic start-up condition) is satisfied.

The stop condition is set so as to include, for example, a condition that the ignition switch 306 is turned on (IG-On), a condition that the accelerator is released (as recognized from the output signal of the accelerator depression amount sensor 303), a condition that the brake pedaling force (as recognized from the output signal of the brake pedal sensor 308) is equal to or greater than a predetermined determination threshold, and a condition that the vehicle CV is stationary (vehicle speed is 0). When the stop condition is satisfied, the ECU 300 issues a command to the injector 215 to terminate fuel injection (i.e., to perform fuel cutoff) so that the engine 201 is automatically shut down (automatic engine shutdown is performed). Ignition cutoff may be performed in addition to the fuel cutoff.

On the other hand, the stop cancellation condition includes, for example, a condition that the pedaling force on the brake pedal is reduced after the stop condition is satisfied and the brake pedaling force becomes smaller than the predetermined determination threshold. The brake pedaling force is recognized from the output signal of the brake pedal sensor 308. When the stop cancellation condition is satisfied while the engine 201 has been automatically shut down (while the engine 201 is in a stopped state due to the stop and start control), the ECU 300 issues commands to the injector 215 and the starter motor 218 to start fuel injection and to activate the starter motor 218 so that cranking of the engine 201 is performed. Thus, the engine 201 is automatically started (automatic engine start is performed).

Next, the fuel increase control at the time of engine start-up will be described. In the vehicle CV shown in FIG. 5, depending on the selected shift range at the time of previous shutdown of the engine 201, a catalyst atmosphere inside the three-way catalyst 217 at the time of engine start-up may be a lean atmosphere, which may lead to increase in the amount of NOx emission at the time of engine start-up.

For example, in a case where the engine 201 is automatically shut down while the selected shift range is the B range or the SSS range for forward travel, at which an engine brake force during deceleration is large, and fuel cutoff during deceleration is being performed, in other words, in a case where the piston is stopped while fuel cutoff is continued in an engine-driven state, the catalyst atmosphere inside the three-way catalyst 217 becomes a lean atmosphere during the engine shutdown process, and therefore, the amount of NOx emission may increase at the time of subsequent automatic engine start-up.

The B range or the SSS range is selected when a large engine brake force is required. Therefore, when the selected shift range is the B range or the SSS range, the frequency of fuel cutoff being performed when the accelerator is released is high as compared to when the selected shift range is the D range.

In consideration of the above, in this embodiment, when the selected shift range at the time of the previous engine shutdown is the B range or the SSS range, a fuel increase value at the time of present engine start-up is increased, as compared to a case where the selected shift range at the time of the previous engine shutdown is other than the B range and the SSS range. Accordingly, an increase in the amount of NOx emission at the time of engine start-up can be prevented. The fuel increase control at the time of engine start-up will be described below in detail.

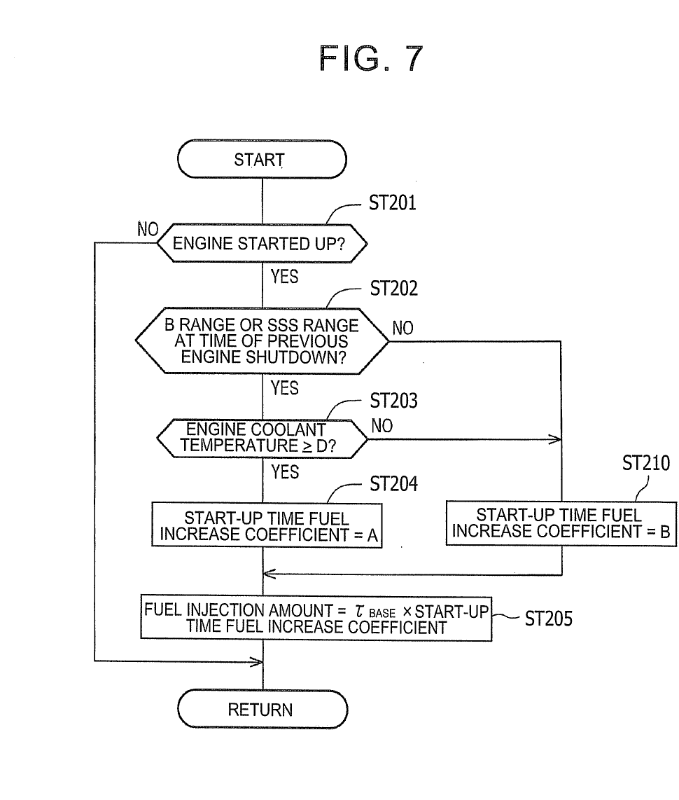

FIG. 7 is a flow chart showing an example of the fuel increase control at the time of engine start-up. A control routine shown in FIG. 7 is repetitively executed in predetermined periods by the ECU 300.

As processing related to the fuel increase control at the time of engine start-up, the ECU 300 executes processing in which every time the engine 201 is shut down, the selected shift range at the time of the engine shutdown is recognized based on the output signal of the shift position sensor 305 and the shift range information is stored in the RAM or the like.

In this embodiment, a base fuel injection amount τ_{BASE} (the same value as in the first embodiment), the coefficient maps shown in Table 1 and Table 2, and a determination value D (D=40° C.) for the engine coolant temperature are stored in the ROM of the ECU 300, as in the first embodiment. In this embodiment, control is performed using the base fuel injection amount τ_{BASE}, the coefficient maps shown in Table 1 and Table 2, and the determination value D.

When the control routine shown in FIG. 7 is started, first, in step ST201, a determination is made on whether or not the engine 201 has been started up (cranking has been performed). When the determination result is a negative determination (NO) (when the engine has been shut down or being operated), a return is made. In the determination process of step ST201, a determination is made on whether or not the engine 201 has been started up, regardless of whether the engine 201 has been started up due to the ignition switch 306 being turned on, or the engine 201 has been automatically started up.

When the determination result of step ST201 is a positive determination (YES), the control routine proceeds to step ST202. In step ST202, information on the selected shift range at the time of previous engine shutdown is read out from the RAM or the like and a determination is made on whether or not the selected shift range at the time of the previous engine shutdown is one of the B range and the SSS range.

When the determination result of step ST202 is a negative determination (NO), in other words, when the selected shift range at the time of the previous engine shutdown is other than the B range and the SSS range (for example, the selected shift range is the D range), the control routine proceeds to step ST210.

In step ST210, the coefficient B (B₀, B₂₀, B₄₀, B₆₀, B₈₀, B₁₀₀, or B₁₁₀) is obtained based on the engine coolant temperature obtained from the output signal of the coolant temperature sensor 304, by referring to the map shown in Table 1. Moreover, when the value of the engine coolant temperature is a value between points on the map shown in Table 1, the coefficient B is obtained by a linear interpolation process or the like.

Next, in step ST205, using the coefficient B obtained in step ST210 and the base fuel injection amount τ_{BASE}, the base fuel injection amount τ_{BASE} is multiplied by the coefficient B to calculate a fuel injection amount at the time of engine start-up (a start-up time fuel increase value). The fuel injection amount at the time of engine start-up is controlled by setting the calculated fuel injection amount as a target fuel injection amount.

On the other hand, when the determination result of step ST202 is a positive determination (YES), in other words, when the selected shift range at the time of the previous engine shutdown is the B range or the SSS range, it is determined that the catalyst atmosphere inside the three-way catalyst 217 is a lean atmosphere and that NOx emission is likely to increase, and the control routine proceeds to step ST203.

In step ST203, a determination is made on whether or not the engine coolant temperature obtained from the output signal of the coolant temperature sensor 304 is equal to or higher than the predetermined determination value D (D=40° C.). When the engine coolant temperature is lower than the determination value D and thus a negative determination (NO) is made in step ST203, processes of step ST210 and step ST205 are executed to calculate the fuel injection amount at the time of engine start-up (the start-up time fuel increase value).

On the other hand, when the engine coolant temperature is equal to or higher than the determination value D and thus a positive determination (YES) is made in step ST203, the control routine proceeds to step ST204.

In step ST204, the coefficient A (A₄₀, A₆₀, A₈₀, A₁₀₀, or A₁₁₀) is obtained based on the engine coolant temperature obtained from the output signal of the coolant temperature sensor 304, by referring to the map shown in Table 2. When the value of the engine coolant temperature is a value between points on the map shown in Table 2, the coefficient A is obtained by a linear interpolation process or the like.

Next, in step ST205, using the coefficient A obtained in step ST204 and the base fuel injection amount τ_{BASE}, the base fuel injection amount τ_{BASE} is multiplied by the coefficient A to calculate the fuel injection amount at the time of engine start-up (the start-up time fuel increase value). When the start-up time fuel increase value is calculated using the coefficient A in this manner, the fuel injection amount at the time of engine start-up (the start-up time fuel increase value) can be increased as compared to when the coefficient B is used. In addition, the fuel injection amount at the time of engine start-up is controlled by setting the fuel injection amount calculated in this manner as the target fuel injection amount.

As described above, according to this embodiment, in the case where the selected shift range at the time of the previous engine shutdown is the B range or the SSS range, the fuel increase value at the time of the present engine start-up can be increased as compared to the case where the selected shift range at the time of the previous engine shutdown is other than the B range and the SSS range. Accordingly, the amount of NOx emission can be prevented from increasing at the time of initial engine start-up.

In the second embodiment described above, a determination on whether or not the selected shift range at the time of the previous engine shutdown is one of the B range and the SSS range is made using information obtained from the output signal of the shift position sensor 305 (hereinafter, shift range information) at the time of the previous engine shutdown. However, the present invention is not limited to this manner.

For example, in a case where the shift range at the time of the engine start-up is the B range or the SSS range, the shift range at the time of the previous engine shutdown is also likely to be the B range or the SSS range. Therefore, the determination on whether or not the selected shift range at the time of the previous engine shutdown is one of the B range and the SSS range may be made using the shift information at the time of the engine start-up (the present engine start-up).

While a configuration in which both the B range and the SSS range can be selected is employed in the embodiments described above, the present invention is not limited to this configuration. A configuration in which only the B range can be selected or a configuration in which only the SSS range can be selected may be employed.

While the paddle switches 9c and 9d are provided on the steering wheel 9b in the embodiments described above, the invention can also be applied to a configuration in which the paddle switches 9c and 9d are not provided.

While a case where the invention is applied to start-up control for an engine provided in a FF vehicle has been described in the embodiments described above, the invention is not limited thereto and can also be applied to start-up control for an engine provided in a front-engine, rear wheel drive (FR) vehicle or in a four-wheel drive vehicle.

The invention is not limited to start-up control for a four-cylinder gasoline engine and can be applied to start-up control for a gasoline engine having another arbitrary number of cylinders. In addition, the invention is not limited to start-up control for a port-injection gasoline engine and can also be applied to a direct-injection gasoline engine. The invention is not limited to start-up control for a gasoline engine and can also be applied to start-up control for other engines such as a diesel engine.

The invention can be utilized to control an engine provided in a vehicle. More specifically, the invention can be effectively utilized for start-up control for an internal combustion engine in which fuel increase control for increasing a fuel injection amount is performed at the time of start-up.

What is claimed is:

1. A start-up control apparatus for an internal combustion engine, the internal combustion engine being provided in a vehicle having a plurality of shift ranges including one or both of a braking range in which a braking force produced when an accelerator is released is greater than in a normal traveling range, and a manual shift range in which a speed ratio is changed by a manual operation performed by a driver, the start-up control apparatus comprising:
a controller programmed to perform fuel increase control for increasing a fuel injection amount at a time of start-up of the internal combustion engine,
the controller being programmed to increase the fuel injection amount at a time of present start-up of the internal combustion engine in a case where a selected shift range at a time of previous shutdown of the internal combustion engine is the braking range or the manual shift range, as compared to a case where the selected shift range at the time of the previous shutdown of the internal combustion engine is other than the braking range and the manual shift range.

2. The start-up control apparatus according to claim 1, wherein
in the case where the selected shift range at the time of the previous shutdown of the internal combustion engine is the braking range or the manual shift range, on condition that a coolant temperature of the internal combustion engine at the time of the present start-up is equal to or higher than a determination value set based on an amount of NOx emission, the controller is programmed to increase the fuel injection amount at the time of the present start-up of the internal combustion engine, as compared to the case where the selected shift range at the time of the previous shutdown of the internal combustion engine is other than the braking range and the manual shift range.

3. The start-up control apparatus according to claim 2, wherein
in the case where the selected shift range at the time of the previous shutdown of the internal combustion engine is the braking range or the manual shift range, when the coolant temperature of the internal combustion engine at the time of the present start-up is lower than the determination value, the controller is programmed to set the fuel injection amount at the time of the present start-up of the internal combustion engine in the same manner as a manner in which the fuel injection amount at the time of the present start-up of the internal combustion engine is set in the case where the selected shift range at the time of the previous shutdown of the internal combustion engine is other than the braking range and the manual shift range.

4. The start-up control apparatus according to claim 1, wherein
in the case where the selected shift range at the time of the previous shutdown of the internal combustion engine is other than the braking range and the manual shift range, the controller is programmed to set the fuel injection amount at the time of the present start-up of the internal combustion engine on condition that a catalyst atmosphere inside an exhaust gas purification catalyst at the time of the previous shutdown of the internal combustion engine is a stoichiometric atmosphere.

5. A start-up control method for an internal combustion engine, comprising:
selecting any of a plurality of shift ranges including one or both of a braking range in which a braking force produced when an accelerator is released is greater than in a normal traveling range, and a manual shift range in which a speed ratio is changed by a manual operation performed by a driver;
increasing a fuel injection amount at a time of start-up of the internal combustion engine; and
increasing the fuel injection amount at a time of present start-up of the internal combustion engine in a case where a selected shift range at a time of previous shutdown of the internal combustion engine is the braking range or the manual shift range, as compared to a case where the selected shift range at the time of the previous shutdown of the internal combustion engine is other than the braking range and the manual shift range.
